(19) United States
(12) Patent Application Publication
(10) Pub. No.: US 2018/0198819 A1
(43) Pub. Date: Jul. 12, 2018

(54) METHOD AND APPARATUS FOR GENERATING INCIDENT GRAPH DATABASE

(71) Applicant: KOREA INTERNET & SECURITY AGENCY, Seoul (KR)

(72) Inventors: Seul Gi Lee, Seoul (KR); Hyei Sun Cho, Seoul (KR); Nak Hyun Kim, Seoul (KR); Byung Ik Kim, Seoul (KR); Tae Jin Lee, Seoul (KR)

(21) Appl. No.: 15/421,062

(22) Filed: Jan. 31, 2017

(30) Foreign Application Priority Data
Jan. 10, 2017 (KR) 10-2017-0003741

(51) Int. Cl. H04L 29/06; H04L 12/24; G06F 17/30

(52) U.S. Cl. CPC H04L 63/1466; H04L 63/1425; G06F 17/30958; H04L 41/12

(57) ABSTRACT

method and apparatus for generating incident graph database are provided, one of methods comprises, generating incident coverage using an apparatus for generating an incident graph database when the incident coverage comprising a first node and a second node connected by a first edge and constituting an incident graph database does not exist, determining whether each of the first node and the second node has additional connection based on a relationship type of the first edge using the apparatus for generating an incident graph database, expanding the incident coverage to further comprise an expansion node using the apparatus for generating an incident graph database, repeating the generating of the incident coverage, the determining of whether each of the first node and the second node has the additional connection, and the expanding of the incident coverage on all edges included in the incident graph database using the apparatus for generating an incident graph database and generating a first incident node in which all nodes and edges included in the incident coverage are connected using the apparatus for generating an incident graph database, wherein the expansion node is a node connected to the first node or the second node determined to have the additional connection.

This application claims the benefit of Korean Patent Application No. 10-2017-0003741, filed on Jan. 10, 2017, in the Korean Intellectual Property Office, the disclosure of which is incorporated herein by reference in its entirety.

### BACKGROUND

### 1. Field

The present inventive concept relates to a method and apparatus for generating an incident graph database, and more particularly, to a method and apparatus for generating an incident graph database by determining whether each node has additional connection.

### 2. Description of the Related Art

To cope with rapidly increasing infringement incidents, information related to infringement incidents is shared between domestic and foreign public institutions and private companies. In addition, various methods are being attempted to prevent attack by infringing resources h refining and managing the shared information about infringement incidents as intelligence information.

One example method may be a graph database of infringing resources (hereinafter, referred to as an “incident graph database”). The graph database is a database in which data is stored in a graph to generalize the structure and improve accessibility. In the incident graph database, infringing resources and attributes of the infringing resources are stored in nodes, and a relationship is recorded in an attribute value of an edge connecting each pair of nodes.

The incident graph database, which is established as a graph database of various infringing resources collected through the network, has a very simple structure because it is composed only of nodes and edges. Therefore, it is easy to establish a strategy for preventing attacks by infringing resources using the incident graph database. However, since infringing resources collected is generally numerous, numerous nodes may be included in the incident graph database, which may make it difficult to access desired data.

Therefore, the incident graph database should be structured as simple as possible by putting various infringement resources into a common denominator and should allow easy access to desired data. In addition, since new infringing resources are collected at every moment, it should be easy to update the established graph database by adding the newly collected infringing resources.

### SUMMARY

Aspects of the inventive concept provide a method and apparatus for generating an incident graph database having a simple structure by putting various infringing resources collected through a network into a common denominator.

Aspects of the inventive concept also provide a method and apparatus for generating an incident graph database which allows easy access to desired data and is easy to update based on infringing resources to be collected by putting various infringing resources collected through a network into a common denominator.

However, aspects of the inventive concept are not restricted to the one set forth herein. The above and other aspects of the inventive concept will become more apparent to one of ordinary skill in the art to which the inventive concept pertains by referencing the detailed description of the inventive concept given below.

In some embodiments, a method for generating incident graph database, the method comprises generating incident coverage using an apparatus for generating an incident graph database when the incident coverage comprising a first node and a second node connected by a first edge and constituting an incident graph database does not exist, determining whether each of the first node and the second node has additional connection based on a relationship type of the first edge using the apparatus for generating an incident graph database, expanding the incident coverage to further comprise an expansion node using the apparatus for generating an incident graph database, repeating the generating of the incident coverage, the determining of whether each of the first node and the second node has the additional connection, and the expanding of the incident coverage on all edges included in the incident graph database using the apparatus for generating an incident graph database and generating a first incident node in which all nodes and edges included in the incident coverage are connected using the apparatus for generating an incident graph database, wherein the expansion node is a node connected to the first node or the second node determined to have the additional connection.

In some embodiments, a computer program stored in a storage medium to cause a computing device to perform a method comprises an operation of generating incident coverage when the incident coverage comprising a first node and a second node connected by a first edge and constituting an incident graph database does not exist, an operation of determining whether each of the first node and the second node has additional connection based on a relationship type of the first edge, an operation of expanding the incident coverage to further comprise an expansion node and an operation of generating a first incident node in which all nodes and edges included in the incident coverage are connected, wherein the expansion node is a node connected to the first node or the second node determined to have the additional connection.

In some embodiments, an apparatus having a feature of generating an incident graph database, the apparatus comprises an incident coverage generator which generates incident coverage comprising a first node and a second node connected by a first edge and constituting an incident graph database when the incident coverage does not exist, an additional connection determinator which determines whether each of the first node and the second node has additional connection based on a relationship type of the first edge, an incident coverage expander which expands the incident coverage to further comprise an expansion node and an incident node generator which generates a first incident node in which all nodes and edges included in the incident coverage are connected, wherein the expansion node is a node connected to the first node or the second node determined to have the additional connection.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates the overall configuration of an apparatus for generating an incident graph database according to an embodiment;

FIG. 2 illustrates an example of incident coverage including a first node and a second node connected by a first edge;

FIGS. 3 and 4 illustrate the process of determining additional connection based on an incident time when an incident was detected, a predetermined threshold, and a relationship time of a relationship type of the first edge;

FIG. 5 illustrates the process of determining additional connection based on an incident time when an incident was detected, a predetermined threshold, and a node time of each of the first node and the second node;

FIG. 6 illustrates the incident coverage expanded by an incident coverage expander to include a third node connected to the first node by an edge and a fourth node connected to the second node by an edge;

FIG. 7 illustrates a first incident group node generated by an incident group node generator to include a first incident node and a second incident node;

FIG. 8 illustrates an example of an incident graph database finally constructed by the apparatus for generating an incident graph database;

FIG. 9 is a flowchart illustrating a method of generating an incident graph database according to an embodiment;

FIG. 10 is a flowchart illustrating a method of determining additional connection using the apparatus for generating an incident graph database; and

FIGS. 11 through 15 illustrate the process of generating the first incident node and the second incident node using the method of generating an incident graph database according to the embodiment.

### DETAILED DESCRIPTION

All terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the present specification, an incident refers to an instance in which a malicious act is performed on assets constituting an information processing system. In addition, infringing resources refer to all information related to an infringement incident, such as a malicious agent, infrastructure for carrying out a malicious act, and a malicious tool. For examples, the infringing resources may include IP, domain, e-mail, and malicious node.

Before describing the inventive concept, it is assumed that a basic form of incident graph database has already been established. Specifically, various infringing resources collected through a network are stored in nodes, and each pair of nodes is connected by a relationship which is one of attributes of an edge.

Hereinafter, the inventive concept will be described in more detail with reference to the accompanying drawings.

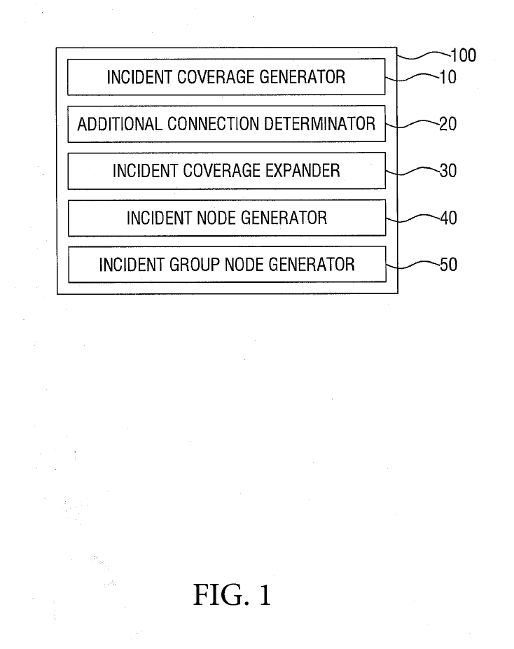

FIG. 1 illustrates the overall configuration of an apparatus 100 for generating an incident graph database according to an embodiment.

The apparatus 100 for generating an incident graph database may include an incident coverage generator 10, an additional connection determinator 20, an incident coverage expander 30, and an incident node generator 40. The apparatus 100 may further include an incident group node generator 50 and other additional components necessary for achieving the objectives of the inventive concept, and some components can be deleted as necessary.

The incident coverage generator 10 generates incident coverage when the incident coverage including a first node and a second node connected by a first edge and constituting an incident graph database does not exist.

Here, each of the first node and the second node may be any one of an infringing resource collected through a network and stored in an incident graph database and an attribute of the infringing resource. For example, if the first node is an infringing resource, the second node may also be an infringing resource or may be an attribute of the infringing resource. If the first node is an attribute of an infringing resource, the second node may also be an attribute of an infringing resource or may be the infringing resource.

Here, an infringing resource may be any one of IP, Domain, Hash and Email, and an attribute of the infringing resource may be any one of URL, URL path, Time, Timestamp, Filename, File path, Registry, Process, Account, Location and String. However, this is merely an example, and the infringing resources and the attributes of the infringing resources should be considered to include all known elements.

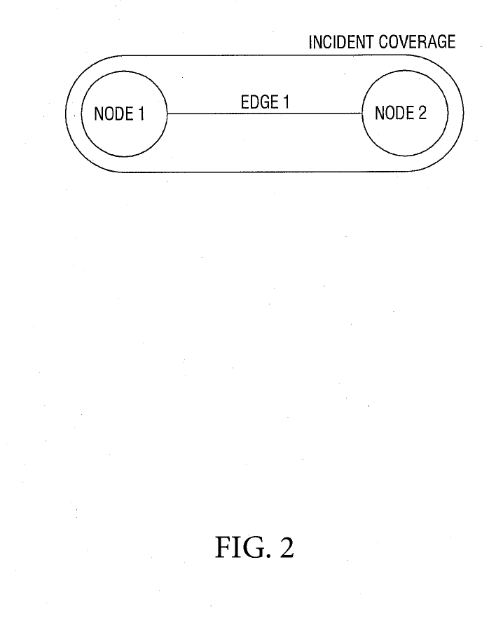

If the incident coverage does not exist, it can be understood that the apparatus 100 for generating an incident graph database is in an initial state before being driven for the first time. In this case, the incident coverage generator 10 initiates the operation of the apparatus 100 by generating the incident coverage. Here, the incident coverage refers to a range in which a first incident node, which will be described later, can be formed. Therefore, when the apparatus 100 starts to be driven for the first time, the infringement coverage generator 10 generates the incident coverage including the first node and the second node connected by the first edge as illustrated in FIG. 2.

The additional connection determinator 20 determines whether each of the first node and the second node has additional connection based on the relationship type of the first edge.

Here, the relationship type may be considered as an attribute value given to the first edge. For example, the relationship type may be any one of Admin, Attack, Authorized_agency, Blacklist, Cnc, Communicate, Create_malware, Composition, Deface, Distribute, Dropped_file, Dropped_file name, Dropped_file Path, Filename, Filestring, Isp, Location, Malicious, Mapping, New_domain, Process, Registrant, Update_domain and Via. However, this should also be considered as a mere example, as in the case of the infringing resources and the attributes of the infringing resources described above.

More specifically, the relationship type is a value indicating by what relationship the first node and the second node are connected. Admin indicates domain owner information, Attack indicates an attacker IP or a victim IP, Authorized_agency indicates a domain registration company, Blacklist is about whether blacklisted or not, CNC is about whether C&C communicable or not, Communicate is about whether communicable or not, Create_malware indicates the creation time of malicious code. Composition indicates the composition of a character string, Deface is about whether IP or domain has been falsified, Distribute is about whether distributed or not, Dropped_file indicates a file created by malicious code, Dropped_filename indicates the name of a file created by malicious code, Dropped_filepath indicates the path of a file created by malicious code, Filename indicates the filename of malicious code. Filestring indicates a character string inside a file, Isp indicates information about a domain registration agency, Location indicates the location of IP or Domain, Malicious is about whether IP, Domain and URL are malicious and about the first occurrence time of malicious code, Mapping is about whether Domain and IP have been mapped to each other, New_domain indicates newly registered domain information, Process indicates process information generated, Registrant indicates the name or e-mail of a domain registrant, Update_domain indicates the modification time of domain registration information, and Via indicates ‘via’ information.

The additional connection of each of the first node and the second node refers to whether each of the first node and the second node can be connected to another node by an edge other than the first edge. For example, if both the first node and the second node have no additional connection, the incident coverage described above is generated only using the first node, the second node and the first edge connecting the first node and the second node. However, if the first node has additional connection and thus can be connected to another node, the incident coverage may be generated by further using the additional node. That is, the additional connection can be considered as an indicator of whether a node has N-connection or 1-connection,

To determine the additional connection of each of the first node and the second node, the additional connection determinator 20 uses a first connection table. The first connection table is shown in Table 1 below. The first connection table defines the additional connection of the first node and the second node connected by the first edge for each relationship type. A specific process in which the additional connection determinator 20 determines additional connection using a connection table will hereinafter be described.

TABLE 1

| | Relationship | Relationship | | | |
|---|---|---|---|---|---|
| No | Type | Description | Node | Node Property | N-Connection |
| 1 | admin | Domain owner | Domain | — | ◯ |
| | | information | Email | — | ◯ |
| | | (Whois) | String | {type: name} | ◯ |
| | | | String | {type: account} | ◯ |
| 2 | attack | Attacker IP ↔ | IP | | X |
| | | Victim IP | IP | | X |
| 3 | authorized_agency | Domain registration | Domain | — | X |
| | | company | String | {type: agency} | X |
| 4 | blacklist | Blacklisted | Domain | — | X |
| | | | IP | — | X |
| | | | Timestamp | — | X |
| 5 | cnc | C&C | Hash | | ◯ |
| | | communication | Domain | | ◯ |
| | | | IP | | ◯ |
| | | | Url | | ◯ |
| 6 | communicate | Communication | Hash | | ◯ |
| | | | IP | | ◯ |
| 7 | create_malware | Creation time of | Hash | | X |
| | | malicious code | Timestamp | | X |
| 8 | composition | Composition of | Domain | | ◯ |
| | | character string | Url | | ◯ |
| | | | Email | | ◯ |
| | | | String | | ◯ |
| 9 | deface | IP/Domain | IP | | X |
| | | falsification | Domain | | X |
| | | | Hash | | X |
| 10 | distribute | Distribute | IP | | ◯ |
| | | | Email | | ◯ |
| | | | Url | | ◯ |
| | | | Domain | | ◯ |
| | | | Hash | | ◯ |
| 11 | dropped_file | File created by | Hash | | ◯ |
| | | malicious code | | | |
| 12 | dropped_filename | Name of file | Hash | | ◯ |
| | | created by | String | {type: name} | ◯ |
| | | malicious code | Filename | | ◯ |
| 13 | dropped_filepath | Path of file | Hash | | ◯ |
| | | created by | String | {type: path} | ◯ |
| | | malicious code | Filepath | | ◯ |
| 14 | filename | Filename of | Hash | | ◯ |
| | | malicious code | String | {type: name} | ◯ |
| | | | Filename | | ◯ |
| 15 | filestring | Character string | Hash | | ◯ |
| | | inside a file | String | | ◯ |
| | | | Filestring | | ◯ |
| 16 | isp | Domain | IP | | X |
| | | registration agency | String | {type: isp} | X |
| | | information | | | |
| 17 | location | Location of | IP | | X |
| | | IP/Domain | Domain | | X |
| | | | Location | | X |
| 18 | malicious | Malicious IP | IP | | ◯ |
| | | Malicious domain | Domain | | ◯ |
| | | Malicious URL | Url | | ◯ |
| | | First occurrence time | Hash | | X |
| | | of malicious code | Timestamp | | X |
| 19 | mapping | Mapping of | Domain | | ◯ |
| | | domain and IP | IP | | ◯ |
| 20 | new_domain | Newly registered | Domain | | X |
| | | domain information | Timestamp | | X |
| 21 | process | Process information | Hash | | X |
| | | generated | Process | | X |
| 22 | registrant | Name/e-mail of | Domain | | ◯ |
| | | domain registrant | String | {type: name} | ◯ |
| | | | Email | | ◯ |
| 23 | update_domain | Modification time of | Domain | | X |
| | | domain registration | Timestamp | | X |
| | | information | | | |
| 24 | via | Via information | IP | | ◯ |
| | | | Domain | | ◯ |
| | | | Url | | ◯ |

If the relationship type of the first edge connecting the first node and the second node is Admin, Admin is searched for in the first connection table. When the relationship type is Admin, four forms of node pairs such as Domain-String, Domain-Email, String-Domain, and Email-Domain can be formed. After that, a pair of nodes in a form corresponding to the first node and the second node is searched for, and it is checked whether the found pair of nodes have N-connection. Since all of the four forms of node pairs have N-connection when the relationship type is Admin, the additional connection determinator 20 determines that the first node and the second node have additional connection.

Next, a case where the relationship type of the first edge connecting the first node and the second node is Authorized_agency will be described. When the relation type is Authorized_agency, two forms of node pairs such as Domain-String and String-Domain can be formed. After that, a pair of nodes in a form corresponding to the first node and the second node is searched for, and it is checked whether the found pair of nodes have N-connection. Since all of the two forms of nodes pairs do not have N-connection when the relationship type is Authorized_agency, the additional connection determinator 20 determines that the first node and the second node have no additional connection (1-Connection).

Next, a case where the relationship type of the first edge connecting the first node and the second node is Malicious will be described. When the relationship type is Malicious, six forms of node pairs such as Domain-URL, IP-URL, URL-IP, URL-Domain, Hash-Timestamp, and Timestamp-Hash can be formed. After that, a pair of nodes in a form corresponding to the first node and the second node is searched for, and it is checked whether the found pair of nodes have N-connection. The relationship type of Malicious is different from the above two relationship types is that not all forms of node pairs have N-connection or do not have N-Connection. Thus, whether the first node and the second node have additional connection is determined differently according to the form of the first node and the second node. For example, if the first node and the second node are in the form of Domain-URL, the additional connection determinator 20 may determine that the first node and the second node have additional connection. On the other hand, if the first node and the second node are in the form of Timestamp-Hash, the additional connection determinator 20 may determine that the first node and the second node do not have additional connection.

The determination of the additional connection by the additional connection determinator 20 based on the first connection table is primary determination. As a result, it is determined whether the first node and the second node have N-connection or 1-connection. The additional connection determinator 20 performs secondary determination on the first node and the second node which were initially determined to have additional connection using the first connection table. This will be described in detail in the following paragraphs.

The additional connection determinator 20 performs secondary determination after performing the primary determination about the above-described additional connection. Specifically, the secondary determination is performed using a table shown in Table 2 below. To distinguish this table from the connection table shown in Table 1, the table below will be referred to as a second connection table.

TABLE 2

| No | Condition | | | Result |
|---|---|---|---|---|
| 1 | N-Connection | {Value} of relationship time is | | N-Connection |
| | is O in first | within +/− {threshold} from | | |
| | connection | incident time | | |
| 2 | table | {Value} of relationship time is | | 1-Connection |
| | | outside +/− {threshold} from | | |
| | | incident time | | |
| 3 | | Relationship | {Value} of | N-Connection |
| | | time = | node time is | |
| | | null \| rtime X | within +/− | |
| | | | {threshold} | |
| | | | from incident | |
| | | | time | |
| 4 | | | {Value} of | 1-Connection |
| | | | node time is | |
| | | | outside +/− | |
| | | | {threshold} | |
| | | | from incident | |
| | | | time or null \| | |
| | | | undefined | |

| | | |
|---|---|---|
| 5 | N-Connection is X in first connection table | 1-Connection |

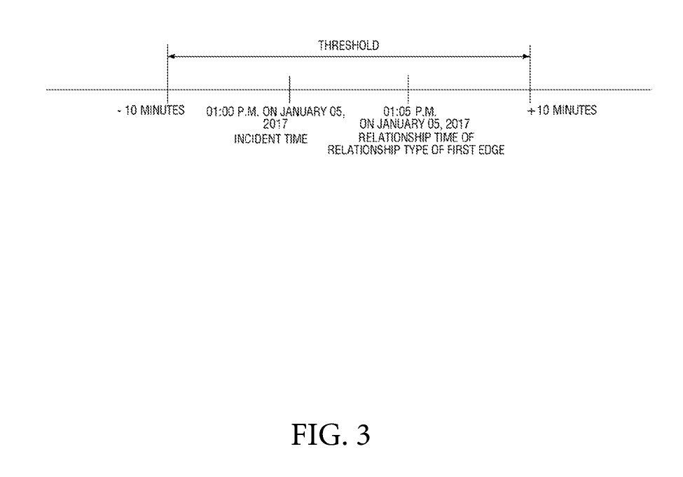

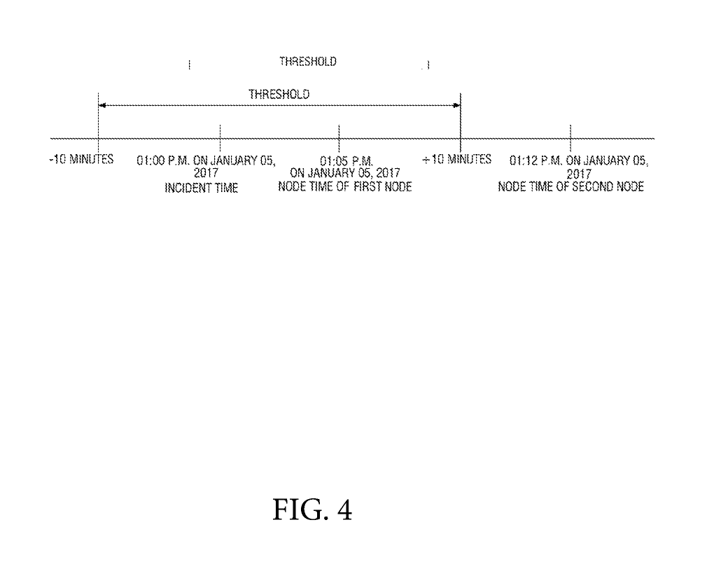

The additional connection determinator 20 checks the relationship time of the relationship type of the first edge in the second connection table and checks whether the relationship time of the relationship type of the first edge is within a predetermined threshold from an incident time when an incident was detected. For example, referring to FIG. 3, in a case where the incident time when an incident was detected is 9:00 p.m. on Jan. 5, 2017, the threshold is ±10 minutes, and the relationship time of the relationship type of the first edge is 9:05 p.m. on Jan. 5, 2017, the additional connection determinator 20 secondarily determines that the first node and the second node have additional connection (N-Connection). Referring to FIG. 4, if the relationship time of the relationship type of the first edge is 9:12 p.m. on Jan. 5, 2017, the additional connection determinator 20 secondarily determines that the first node and the second node have no additional connection (1-Connection). Therefore, even though the first node and the second node are primarily determined to have additional connection based on the first connection table, they can be secondarily determined to have no additional connection based on the second connection table.

Here, if the incident time is null or nonexistent, the additional connection determinator 20 may check an initial value of the relationship time of the relationship type is within a predetermined threshold. The threshold can be freely set by the administrator of the apparatus 100 for generating an incident graph database.

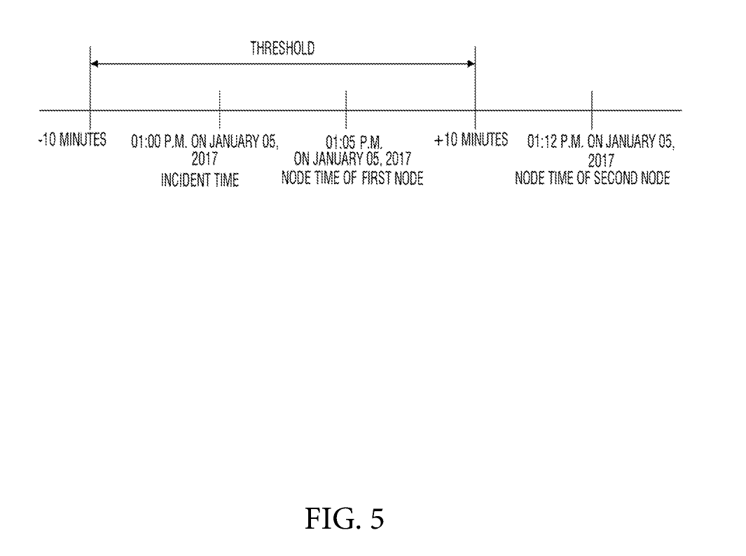

There may be cases where the relationship time of the relationship type of the first edge is null or nonexistent. In these cases, the additional connection determinator 20 checks a node time of each of the first node and the second node instead of the relationship time of the relationship type of the first edge and checks whether the node time of each of the first node and the second node is within a predetermined threshold from the incident time. For example, referring to FIG. 5, in a case where the incident time when an incident was detected is 9:00 p.m. on Jan. 5, 2017, the threshold is ±10 minutes, the node time of the first node is 9:05 p.m. on Jan. 5, 2017, and the node time of the second node is 9:12 p.m. on Jan. 5, 2017, the additional connection determinator 20 secondarily determines that the first node has additional connection and that the second node has no additional connection.

Determining whether the first node and the second node have additional connection based on whether the node time of each of the first node and the second node is within a predetermined threshold from the incident time is different from determining whether the first node and the second node have additional connection based on whether the relationship time of the relationship type of the first edge is within a predetermined threshold from the incident time in that different determination results can be produced for the first node and the second node when the node time of each of the first node and the second node is used. When the relationship time of the relationship type of the first edge is used, different determination results cannot be produced for the first node and the second node. That is, since the relationship type of the first edge has only one relationship time, the first node and the second node can only be determined to have either N-connection or 1-connection.

The additional connection determinator 20 may check whether the node time of each of the first node and the second node is within a predetermined threshold from the incident time only when the relationship time of the relationship type of the first edge is null or nonexistent. That is, since the first edge connecting the first node and the second node and the relationship type given to the first edge in the incident graph database are put into a common denominator, it is desirable in terms of accuracy for the first node and the second node to have the same additional connection determination result.

When the additional connection determinator 20 checks whether the node time of each of the first node and the second node is within a predetermined threshold from the incident time, if the incident time is null or nonexistent, the additional connection determinator 20 may check an initial value of the node time of one of the first node and the second node is within a predetermined threshold. The threshold can be freely set by the administrator of the apparatus 100 for generating an incident graph database.

The incident coverage expander 30 expands the incident coverage to further include an expansion node connected to the first or second node determined to have additional connection by the additional connection determinator 20.

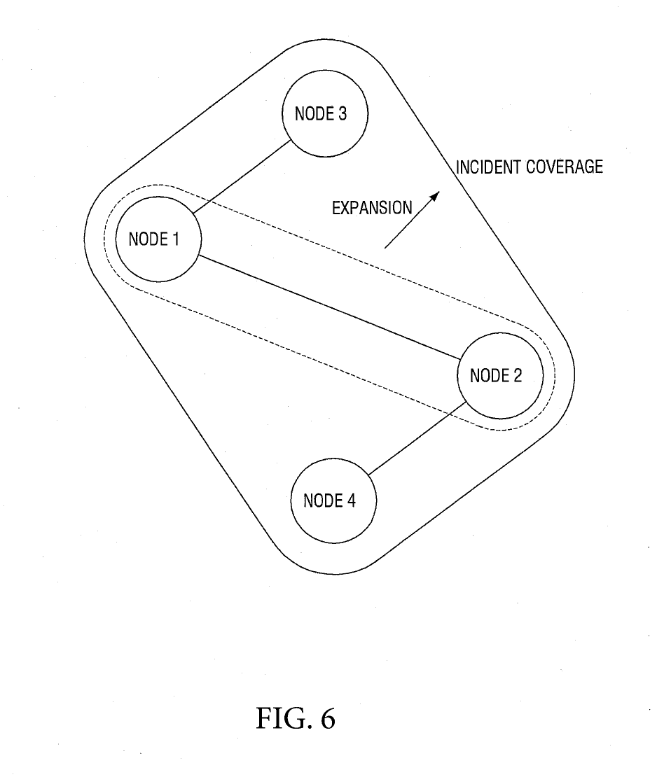

To put it simply, if both the first node and the second node are determined to have additional connection, the incident coverage may be expanded as illustrated in FIG. 6 to include a third node connected to the first node by an edge and a fourth node connected to the second node by an edge.

A more detailed description will be made later in the description of a method of generating an incident graph database according to an embodiment.

The incident node generator 40 generates a first incident node in which all nodes and edges included in the incident coverage expanded by the incident coverage expander 30 are connected.

Here, the first incident node may include two nodes and one edge connecting the two nodes or may include more nodes and more edges depending on the incident coverage. The number of nodes and edges included in the first incident node may be determined by additional connection. Therefore, when the additional connection determinator 20 determines that both the first node and the second node have no additional connection, the first incident node may include the first node, the second node and the first edge connecting the first node and the second node. On the other hand, when the additional connection determinator 20 determines that any one or more of the first node and the second node have additional connection, the first incident node may include another node and edge in addition to the first node and the second node.

The incident group node generator 50 generates a first incident group node by checking whether any one node included in the first incident node is connected to any one node included in a second incident node by an edge.

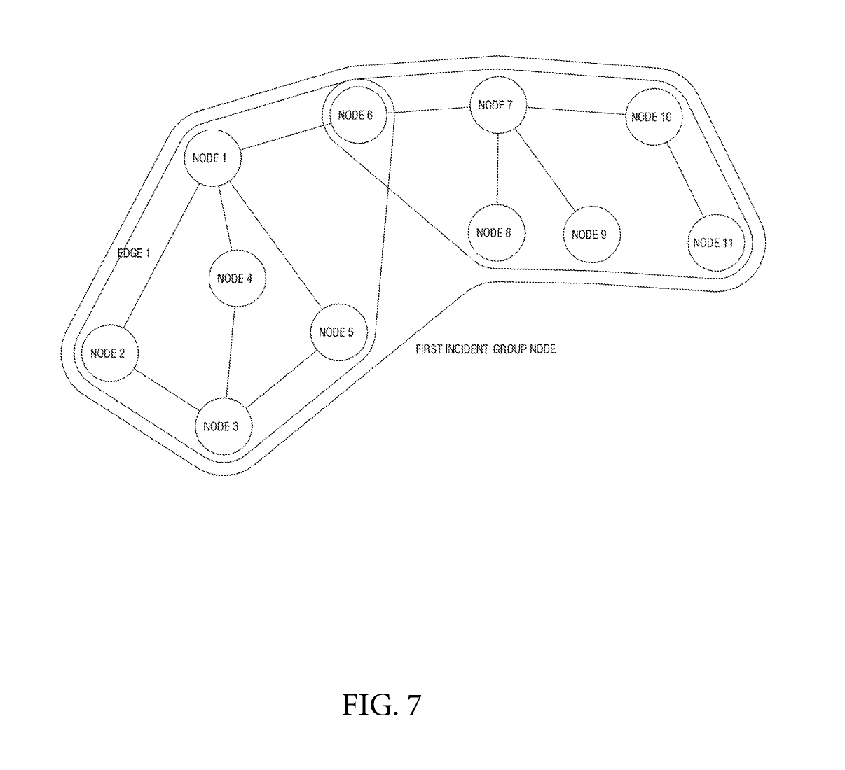

The first incident group node can be found in FIG. 7. In FIG. 7, a first incident node including first through sixth nodes and a second incident node including sixth through eleventh nodes are illustrated. The first incident node and the second incident node are connected to each other by an edge through the sixth node. In this case, the incident group node generator 50 may generate the first incident group node including the first incident node and the second incident node.

Until now, the apparatus 100 for generating an incident graph database according to the embodiment has been described. The apparatus 100 for generating an incident graph database can be implemented in the form of a server. The server may be either a physical server or a cloud server existing on a network.

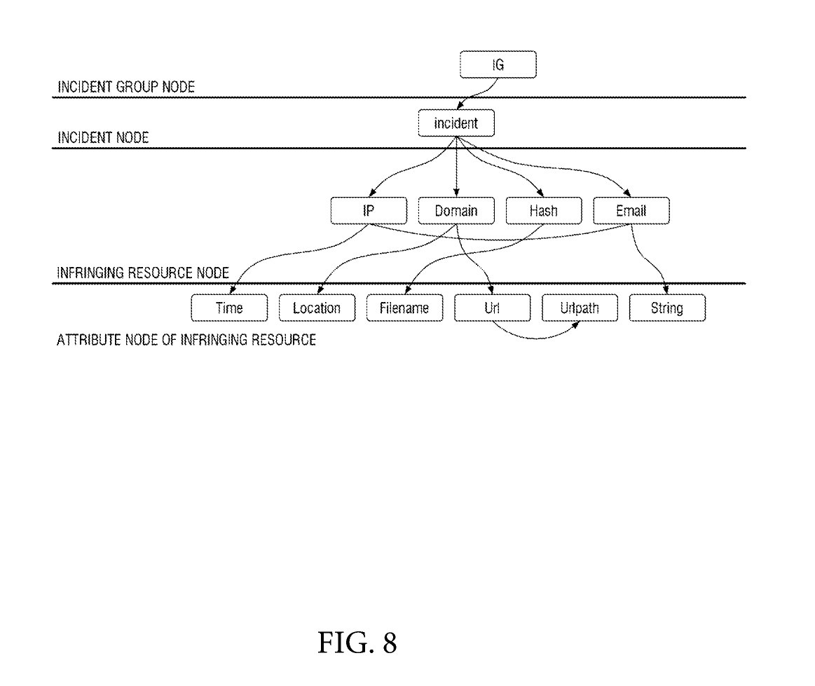

The apparatus 100 for generating an incident graph group database can construct a graph database having a simple structure by generating incident nodes, by extension, an incident group node. An example of the final constructed incident graph database is illustrated in FIG. 8. In addition, since the incident nodes and the incident group node are generated through the common denominator that the relationship time or the node time is within a predetermined threshold from the incident time, it is easy to access desired data and update the graph database based on infringement resources to be collected.

The apparatus 100 for generating an incident graph database according to the embodiment can be implemented in the form of a server, which is a kind of device. The server may be either a physical server or a cloud server existing on a network.

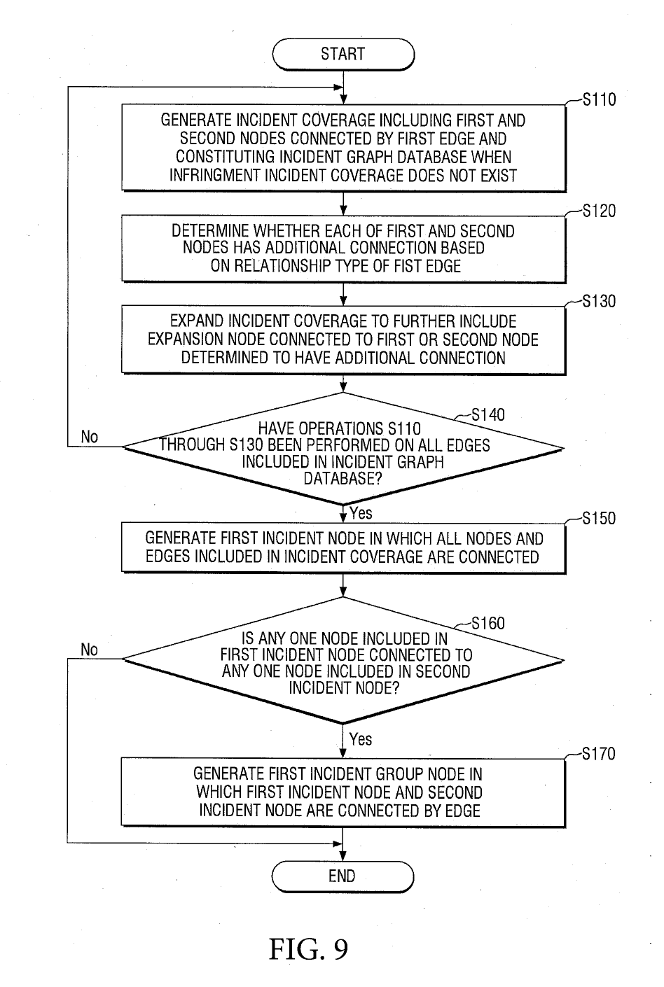

Hereinafter, a method of generating an incident graph database according to an embodiment will be described with reference to FIGS. 9 through 15.

FIG. 9 is a flowchart illustrating a method of generating an incident graph database according to an embodiment. However, this is merely an embodiment for achieving the objectives of the inventive concept, and some operations can be added or deleted as necessary.

The operations are performed by the incident coverage generator 10, the additional connection determinator 20, the incident coverage expander 30, the incident node generator 40 and the incident group node generator 50 of the apparatus 100 for generating an incident graph database, respectively. However, for ease of description, it will be assumed that the operations are performed by the apparatus 100 for generating an incident graph database.

Referring to FIG. 9, when incident coverage including a first node and a second node connected by a first edge and constituting an incident graph database does not exist, the apparatus 100 for generating an incident graph database generates the incident coverage (operation S110).

Here, each of the first node and the second node may be any one of an infringing resource collected through a network and stored in an incident graph database and an attribute of the infringing resource. For example, if the first node is an infringing resource, the second node may also be an infringing resource or may be an attribute of the infringing resource. If the first node is an attribute of an infringing resource, the second node may also be an attribute of an infringing resource or may be the infringing resource.

Here, an infringing resource may be any one of IP, Domain, Hash and Email, and an attribute of the infringing resource may be any one of URL, URL path, Time, Timestamp, Filename, File path, Registry, Process, Account, Location and String. However, this is merely an example, and the infringing resources and the attributes of the infringing resources should be considered to include all known elements.

If the incident coverage does not exist, it can be understood that the apparatus 100 for generating an incident graph database is in an initial state before being driven for the first time. In this case, the incident coverage generator 10 initiates the operation of the apparatus 100 by generating the incident coverage. Here, the incident coverage refers to a range in which a first incident node, which will be described later, can be formed. Therefore, when the apparatus 100 starts to be driven for the first time, the infringement coverage generator 10 generates the incident coverage including the first node and the second node connected by the first edge as illustrated in FIG. 2 described above.

Next, the apparatus 100 for generating an incident graph database determines whether each of the first node and the second node has additional connection based on the relationship type of the first edge (operation S120).

Here, the relationship type may be considered as an attribute value given to the first edge. For example, the relationship type may be any one of Admin, Attack, Authorized_agency, Blacklist, Cnc, Communicate, Create_malware, Composition, Deface, Distribute, Dropped_file, Dropped_file name, Dropped_file Path, Filename, Filestring, Isp, Location, Malicious, Mapping, New_domain, Process, Registrant, Update_domain and Via. However, this should also be considered as a mere example, as in the case of the infringing resources and the attributes of the infringing resources described above.

More specifically, the relationship type is a value indicating by what relationship the first node and the second node are connected. Admin indicates domain owner information, Attack indicates an attacker IP or a victim IP, Authorized_agency indicates a domain registration company, Blacklist is about whether blacklisted or not, CNC is about whether C&C communicable or not, Communicate is about whether communicable or not, Create_malware indicates the creation time of malicious code, Composition indicates the composition of a character string, Deface is about whether IP or domain has been falsified, Distribute is about whether distributed or not, Dropped_file indicates a file created by malicious code, Dropped_filename indicates the name of a file created by malicious code, Dropped_filepath indicates the path of a file created by malicious code, Filename indicates the filename of malicious code, Filestring indicates a character string inside a file, Isp indicates information about a domain registration agency, Location indicates the location of IP or Domain, Malicious is about whether IP, Domain and URL are malicious and about the first occurrence time of malicious code, Mapping is about whether Domain and IP have been mapped to each other, New_domain indicates newly registered domain information, Process indicates process information generated, Registrant indicates the name or e-mail of a domain registrant, Update_domain indicates the modification time of domain registration information, and Via indicates ‘via’ information.

The additional connection of each of the first node and the second node refers to whether each of the first node and the second node can be connected to another node by an edge other than the first edge. For example, if both the first node and the second node have no additional connection, the incident coverage described above is generated only using the first node, the second node and the first edge connecting the first node and the second node. However, if the first node has additional connection and thus can be connected to another node, the incident coverage may be generated by further using the additional node. That is, the additional connection can be considered as an indicator of whether a node has N-connection or 1-connection.

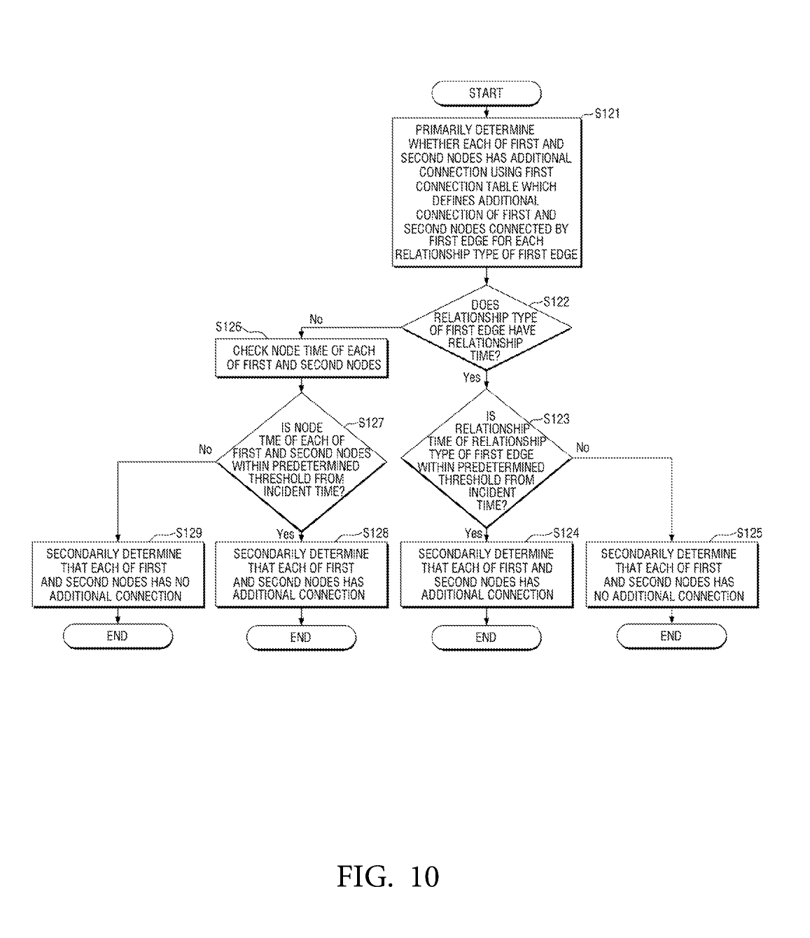

To determine whether each of the first node and the second node has additional connection, operation S120 may be subdivided. FIG. 10 is a flowchart illustrating a method of determining additional connection using the apparatus 100 for generating an incident graph database. The method of determining additional connection will be described in detail with reference to FIG. 10.

Referring to FIG. 10, the apparatus 100 for generating an incident graph database primarily determines whether each of the first node and the second node has additional connection by using a first connection table which defines the additional connection of the first node and the second node connected by the first edge for each relationship type (operation S121).

Here, the first connection table is shown in Table 1 described above and defines the additional connection of the first node and the second node connected by the first edge for each relationship type. The method of primarily determining whether each of the first node and the second node has additional connection using the first connection table will be described below using some relationship types as examples.

If the relationship type of the first edge connecting the first node and the second node is Admin, Admin is searched for in the first connection table. When the relationship type is Admin, four forms of node pairs such as Domain-String, Domain-Email, String-Domain, and Email-Domain can be formed. After that, a pair of nodes in a form corresponding to the first node and the second node is searched for, and it is checked whether the found pair of nodes have N-connection. Since all of the four forms of node pairs have N-connection when the relationship type is Admin, the apparatus 100 for generating an incident graph database determines that the first node and the second node have additional connection.

Next, a case where the relationship type of the first edge connecting the first node and the second node is Authorized_agency will be described. When the relation type is Authorized _agency, two forms of node pairs such as Domain-String and String-Domain can be formed. After that, a pair of nodes in a form corresponding to the first node and the second node is searched for, and it is checked whether the found pair of nodes have N-connection. Since all of the two forms of nodes pairs do not have N-connection when the relationship type is Authorized _agency, the apparatus 100 determines that the first node and the second node have no additional connection (1-Connection).

Next, a case where the relationship type of the first edge connecting the first node and the second node is Malicious will be described. When the relationship type is Malicious, six forms of node pairs such as Domain-URL, IP-URL, URL-IP URL-Domain, Hash-Timestamp, and Timestamp-Hash can be formed. After that, a pair of nodes in a form corresponding to the first node and the second node is searched for, and it is checked whether the found pair of nodes have N-connection. The relationship type of Malicious is different from the above two relationship types is that not all forms of node pairs have N-connection or do not have N-Connection. Thus, whether the first node and the second node have additional connection is determined differently according to the form of the first node and the second node. For example, if the first node and the second node are in the form of Domain-URL, the apparatus 100 for generating an incident graph database may determine that the first node and the second node have additional connection. On the other hand, if the first node and the second node are in the form of Timestamp-Hash, the apparatus 100 may determine that the first node and the second node do not have additional connection.

The determination of the additional connection by the apparatus 100 based on the first connection table is primary determination. As a result, it is determined whether the first node and the second node have N-connection or 1-connection. The apparatus 100 performs secondary determination on the first node and the second node which were initially determined to have additional connection using the first connection table. This will be described in detail in the following paragraphs.

When each of the first node and the second is primarily determined to have additional connection in operation S121, the apparatus 100 checks whether the relationship type of the first edge has a relationship time (operation S122). When the relationship type of the first edge has the relationship time, the apparatus 100 checks whether the relationship time of the relationship type of the first edge is within a predetermined threshold from an incident time when an incident was detected (operation S123). When the relationship time of the relationship type of the first edge is within the predetermined threshold from the incident time, the apparatus 100 secondarily determines that each of the first node and the second node has additional connection (operation S124). On the other hand, when the relationship type of the relationship type of the first edge is not within the predetermined threshold from the incident time, the apparatus 100 secondarily determines that each of the first node and the second node does not have additional connection (operation S125).

The secondary determination performed by the apparatus 100 in operations S124 and S125 is based on a second connection table shown in Table 2 described above. Like the primary determination performed using the first connection table, the secondary determination performed using the second connection table will be described below using some examples.

For example, in a case where the incident time when an incident was detected is 9:00 p.m. on Jan. 5, 2017, the threshold is ±10 minutes, and the relationship time of the relationship type of the first edge is 9:05 p.m. on Jan. 5, 2017, the apparatus 100 secondarily determines that the first node and the second node have additional connection (N-Connection). If the relationship time of the relationship type of the first edge is 9:12 p.m. on Jan. 5, 2017, the apparatus 100 secondarily determines that the first node and the second node have no additional connection (1-Connection). Therefore, even though the first node and the second node are primarily determined to have additional connection based on the first connection table, they can be secondarily determined to have no additional connection based on the second connection table.

Here, if the incident time is null or nonexistent, the apparatus 100 may check whether an initial value of the relationship time of the relationship type is within a predetermined threshold. The threshold can be freely set by the administrator of the apparatus 100 for generating an incident graph database.

There may be cases where the relationship time of the relationship type of the first edge is null or nonexistent in operation S122. In these cases, the apparatus 100 checks a node time of each of the first node and the second node instead of the relationship time of the relationship type of the first edge (operation S126) and checks whether the node time of each of the first node and the second node is within a predetermined threshold from the incident time (operation S127). When the node time of each of the first node and the second node is within the predetermined threshold from the incident time, the apparatus 100 secondarily determines that each of the first node and the second node has additional connection (operation S128). On the other hand, when the node time of each of the first node and the second node is not within the predetermined threshold from the incident time, the apparatus 100 secondarily determines that each of the first node and the second node has no additional connection (operation S129). For example, in a case where the incident time when an incident was detected is 9:00 p.m. on Jan. 5, 2017, the threshold is ±10 minutes, the node time of the first node is 9:05 p.m. on Jan. 5, 2017, and the node time of the second node is 9:12 p.m. on Jan. 5, 2017, the apparatus 100 secondarily determines that the first node has additional connection and that the second node has no additional connection.

Determining whether the first node and the second node have additional connection based on operations S126 through S129 in which it is checked whether the node time of each of the first node and the second node is within a predetermined threshold from the incident time is different from determining whether the first node and the second node have additional connection based on operations S122 through S125 in which it is checked whether the relationship time of the relationship type of the first edge is within a predetermined threshold from the incident time in that different determination results can be produced for the first node and the second node when the node time of each of the first node and the second node is used. When the relationship time of the relationship type of the first edge is used, different determination results cannot be produced for the first node and the second node. That is, since the relationship type of the first edge has only one relationship time, the first node and the second node can only be determined to have either N-connection or 1-connection.

The apparatus 100 may check whether the node time of each of the first node and the second node is within a predetermined threshold from the incident time only when the relationship time of the relationship type of the first edge is null or nonexistent. That is, since the first edge connecting the first node and the second node and the relationship type given to the first edge in the incident graph database are put into a common denominator, it is desirable in terms of accuracy for the first node and the second node to have the same additional connection determination result.

When the apparatus 100 checks whether the node time of each of the first node and the second node is within the predetermined threshold from the incident time in operation S125, if the incident time is null or nonexistent, the apparatus 100 may check an initial value of the node time of one of the first node and the second node is within a predetermined threshold. The threshold can be freely set by the administrator of the apparatus 100 for generating an incident graph database.

After determining whether each of the first node and the second node has additional connection, the apparatus 100 expands the incident coverage to further include an expansion node connected to the first or second node determined to have additional connection (operation S130). Operations S110 through S130 are repeated on all edges included in the incident graph database (operation S140). Then, a first incident node in which all nodes and edges included in the incident coverage are connected is generated (operation S150).

Here, the first incident node may include two nodes and one edge connecting the two nodes or may include more nodes and more edges depending on the incident coverage. The number of nodes and edges included in the first incident node may be determined by additional connection. Therefore, when it is determined in operation S120 that both the first node and the second node have no additional connection, the first incident node may include the first node, the second node and the first edge connecting the first node and the second node. On the other hand, when it is determined that any one or more of the first node and the second node have additional connection, the first incident node may include another node and edge in addition to the first node and the second node.

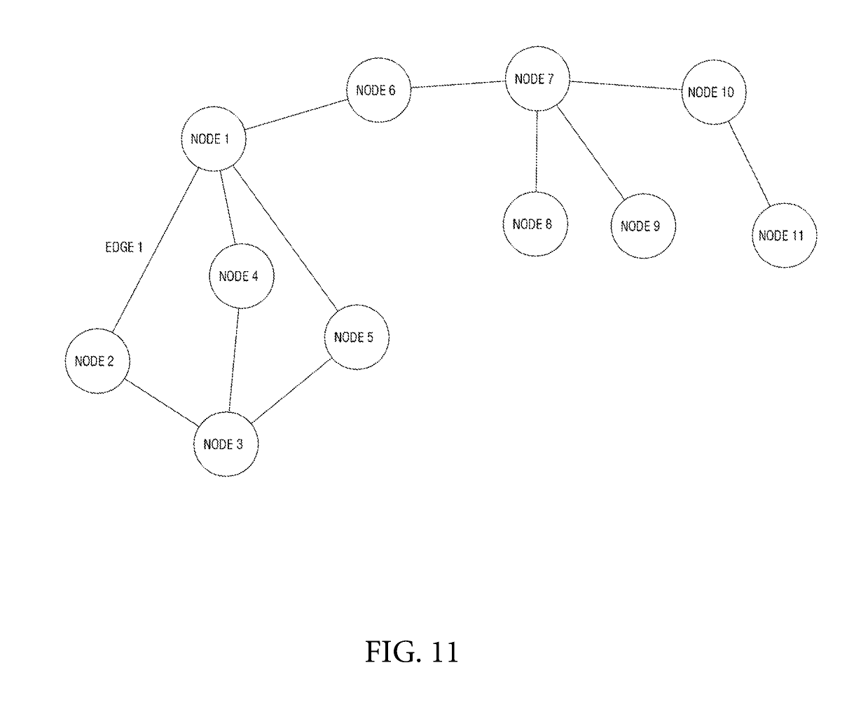

As the incident coverage including all edges and nodes connected by the edges in the incident graph database are expanded through operations S110 through S150, a first incident node is generated. The process of generating an incident node will now be sequentially described with reference to FIGS. 11 through 15.

FIG. 11 illustrates first through eleventh edges and first through eleventh nodes connected by the first through eleventh edges included in an incident graph database. In FIG. 11, an initial state in which no infringement coverage exists since the apparatus 100 for generating an incident graph database has not yet been operated once is illustrated.

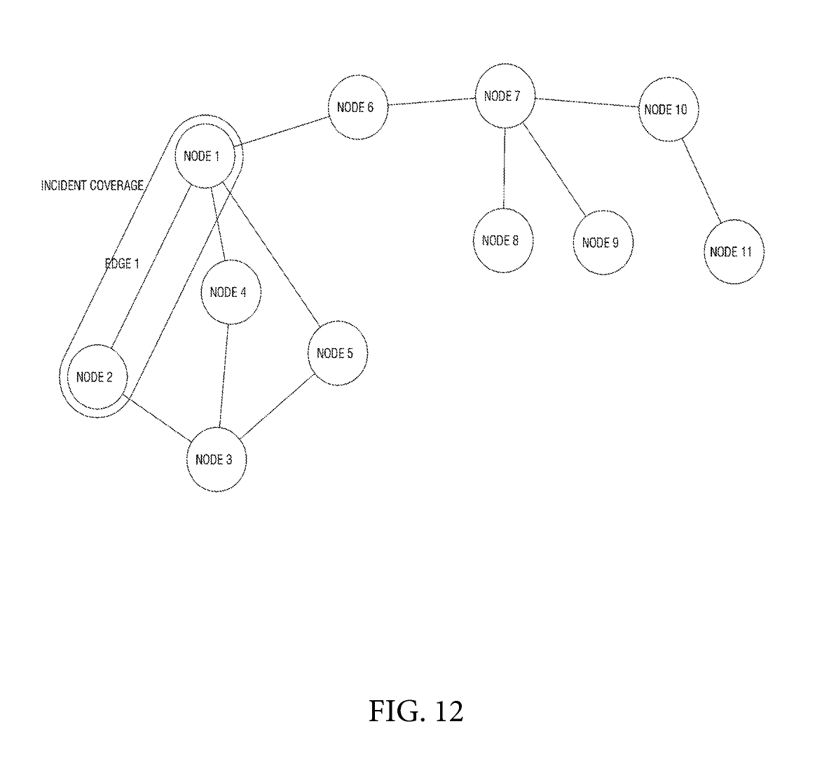

First, incident coverage is generated according to operation S110. The generated incident coverage is illustrated in FIG. 12. For ease of description, it is assumed that the incident coverage is generated to include the first and second nodes and the first edge connecting the first and second nodes.

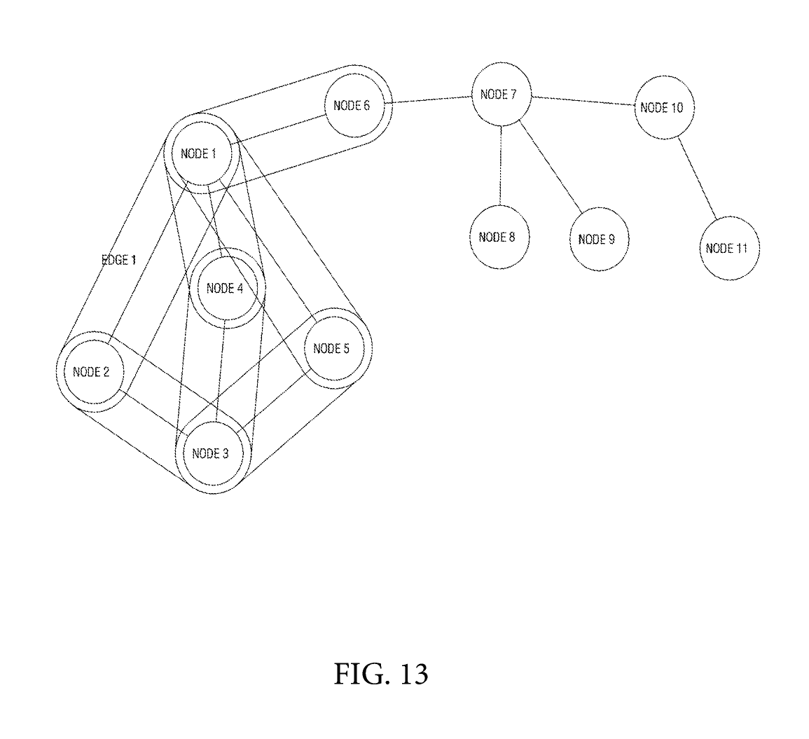

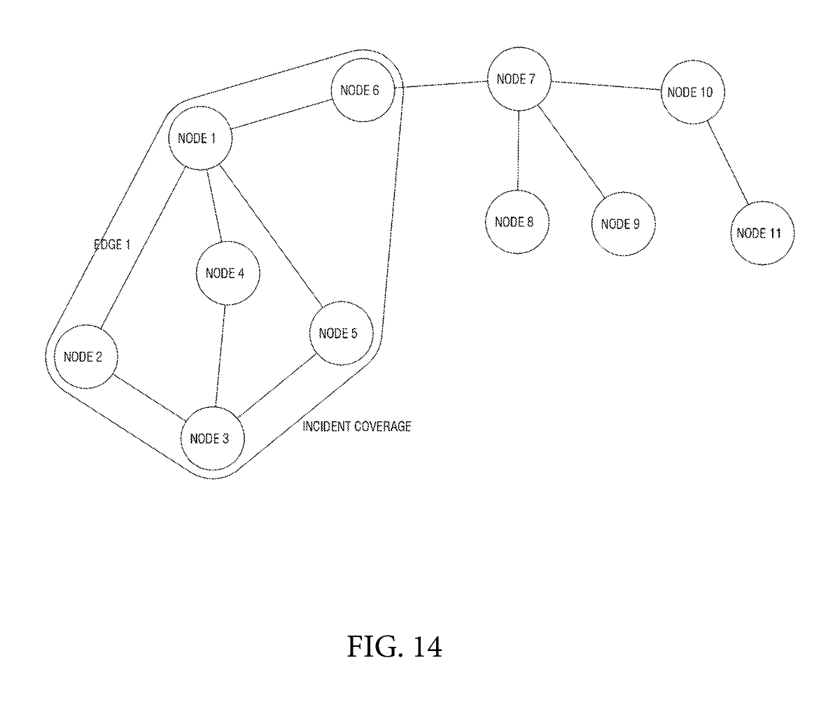

According to operation S120, it is determined whether each of the first node and the second node has additional connection. For ease of description, it is assumed that both the first node and the second node are determined to have additional connection. Based on this assumption, expansion nodes are identified according to operation S130. For example, the fourth through sixth nodes are expansion nodes of the first node, and the third node is an expansion node of the second node, as illustrated in FIG. 13. The incident coverage including all of these nodes is illustrated in FIG. 14.

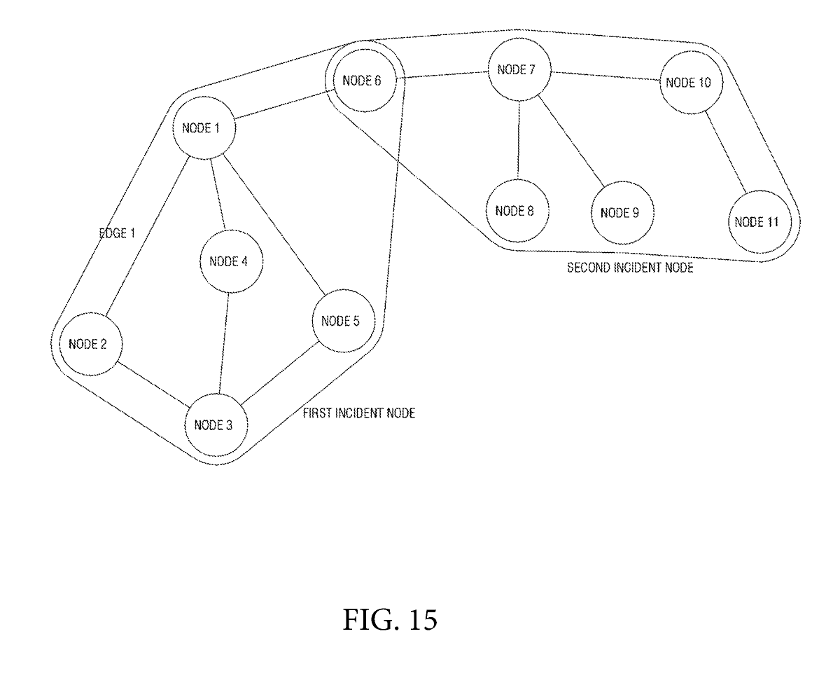

According to operation S140, operations S110 through S130 are repeated on all edges included in the incident graph database. In this case, two incident coverages are generated. According to operation S150, the two coverages are generated as a first incident node and a second incident node as illustrated in FIG. 15.

The process of generating an incident node described with reference to FIGS. 11 through 15 is merely an example. Even if more nodes and edges are included in the incident graph database, an incident node may be generated through the same process.

After the incident nodes are generated, the apparatus 100 for generating an incident graph database checks whether any one node included in the first incident node is connected to any one node included in the second incident node by an edge (operation S160). When any one node included in the first incident node is connected to any one node included in the second incident node by an edge, the apparatus 100 generates a first incident group node in which the first incident node and the second incident node are connected by an edge (operation S170), as illustrated in FIG. 7.

Until now, the method of generating an incident graph database according to the embodiment has been described. The method can be used to construct a graph database having a simple structure by generating incident nodes, by extension, an incident group node. In addition, since the incident nodes and the incident group node are generated through the common denominator that the relationship time or the node time is within a predetermined threshold from the incident time, it is easy to access desired data and update the graph database based on infringement resources to be collected.

The method of generating an incident graph database according to the embodiment can be implemented in the form of a program stored in a storage medium or a medium executable by a computer. In this case, all the technical features of the method of generating an incident graph database can be implemented in the same way by the program. However, a detailed description of the program will be omitted to avoid a redundant description.

According to the inventive concept, it is possible to construct an incident graph database having a simple structure by putting various infringing resources collected through a network into a common denominator.

In addition, it is possible to make it easy to access desired data and update the incident graph database based on infringing resources to be collected by putting various infringing resources collected through the network into a common denominator.

However, the effects of the inventive concept are not restricted to the one set forth herein. The above and other effects of the inventive concept will become more apparent to one of daily skill in the art to which the inventive concept pertains by referencing the claims.

What is claimed is:

1. A method of generating an incident graph database, the method comprising:
generating incident coverage using an apparatus for generating an incident graph database when the incident coverage comprising a first node and a second node connected by a first edge and constituting an incident graph database does not exist;
determining whether each of the first node and the second node has additional connection based on a relationship type of the first edge using the apparatus for generating an incident graph database;
expanding the incident coverage to further comprise an expansion node using the apparatus for generating an incident graph database;
repeating the generating of the incident coverage, the determining of whether each of the first node and the second node has the additional connection, and the expanding of the incident coverage on all edges included in the incident graph database using the apparatus for generating an incident graph database; and
generating a first incident node in which all nodes and edges included in the incident coverage are connected using the apparatus for generating an incident graph database,
wherein the expansion node is a node connected to the first node or the second node determined to have the additional connection.

2. The method of claim 1, wherein the determining of whether each of the first node and the second node has the additional connection comprises primarily determining whether each of the first node and the second node has the additional connection using a first connection table which defines the additional connection of the first node and the second node connected by the first edge for each relationship type by using the apparatus for generating an incident graph database.

3. The method of claim 2, wherein, when it is determined in the primarily determining of whether each of the first node and the second node has the additional connection that each of the first node and the second node has the additional connection, further comprises,
checking a relationship time of the relationship type of the first edge using the apparatus for generating an incident graph database; and
checking whether the relationship time of the relationship type of the first edge is within a predetermined threshold from an incident time when an incident was detected using the apparatus for generating an incident graph database.

4. The method of claim 3, wherein, when it is identified in the checking of whether the relationship time of the relationship type of the first edge is within the predetermined threshold from the incident time that the relationship time of the relationship type of the first edge is within the predetermined threshold from the incident time, further comprises,
secondarily determining that each of the first node and the second node has the additional connection using the apparatus for generating an incident graph database after the checking of whether the relationship time of the relationship type of the first edge is within the predetermined threshold from the incident time.

5. The method of claim 3, wherein, when it is identified in the checking of whether the relationship time of the relationship type of the first edge is within the predetermined threshold from the incident time that the relationship time of the relationship type of the first edge is not within the predetermined threshold from the incident time, further comprises,
secondarily determining that each of the first node and the second node has no additional connection after the checking of whether the relationship time of the relationship type of the first edge is within the predetermined threshold from the incident time.

6. The method of claim 3, wherein, when it is identified in the checking of the relationship time of the relationship type of the first edge that the relationship time of the relationship type of the first edge is null or nonexistent, further comprises,
checking a node time of each of the first node and the second node using the apparatus for generating an incident graph database; and
checking whether the node time of each of the first node and the second node is within a predetermined threshold from the incident time when the incident was detected using the apparatus for generating an incident graph database.

7. The method of claim 6, wherein, when it is identified in the checking of whether the node time of each of the first node and the second node is within the predetermined threshold from the incident time that the node time of each of the first node and the second node is within the predetermined threshold from the incident time, further comprises,
secondarily determining that each of the first node and the second node has the additional connection using the apparatus for generating an incident graph database after the checking of whether the node time of each of the first node and the second node is within the predetermined threshold from the incident time.

8. The method of claim 6, wherein, when it is identified in the checking of whether the node time of each of the first node and the second node is within the predetermined threshold from the incident time that the node time of each of the first node and the second node is not within the predetermined threshold from the incident time, further comprises,
secondarily determining that each of the first node and the second node has no additional connection using the apparatus for generating an incident graph database after the checking of whether the node time of each of the first node and the second node is within the predetermined threshold from the incident time.

9. The method of claim 1, further comprising checking whether any one node included in the first incident node is connected to any one node included in a second incident node by an edge using the apparatus for generating an incident graph database after the generating of the first incident node.

10. The method of claim 9, when it is identified in the checking of whether any one node included in the first incident node is connected to any one node included in the second incident node by the edge that any one node included in the first incident node is connected to any one node included in the second incident node by the edge, further comprises,
generating a first incident group node in which the first incident node and the second incident node are connected by the edge after the checking of whether any one node included in the first incident node is connected to any one node included in the second incident node by the edge.

11. A computer program coupled to a computing device and recorded in a storage medium to execute:
an operation of generating incident coverage when the incident coverage comprising a first node and a second node connected by a first edge and constituting an incident graph database does not exist;
an operation of determining whether each of the first node and the second node has additional connection based on a relationship type of the first edge;
an operation of expanding the incident coverage to further comprise an expansion node; and
an operation of generating a first incident node in which all nodes and edges included in the incident coverage are connected,
wherein the expansion node is a node connected to the first node or the second node determined to have the additional connection.

12. An apparatus for generating an incident graph database, the apparatus comprising:
an incident coverage generator which generates incident coverage comprising a first node and a second node connected by a first edge and constituting an incident graph database when the incident coverage does not exist;
an additional connection determinator which determines whether each of the first node and the second node has additional connection based on a relationship type of the first edge;
an incident coverage expander which expands the incident coverage to further comprise an expansion node; and
an incident node generator which generates a first incident node in which all nodes and edges included in the incident coverage are connected,
wherein the expansion node is a node connected to the first node or the second node determined to have the additional connection.

13. The apparatus of claim 12, wherein the additional connection determinator primarily determines whether each of the first node and the second node has the additional connection using a first connection table which defines the additional connection of the first node and the second node connected by the first edge for each relationship type.

14. The apparatus of claim 13, wherein, when primarily determining that each of the first node and the second node has the additional connection using the first connection table, the additional connection determinator checks a relationship time of the relationship type of the first edge and secondarily determines whether each of the first node and the second node has the additional connection by checking whether the relationship time of the relationship type of the first edge is within a predetermined threshold from an incident time when an incident was detected.

15. The apparatus of claim 12, further comprising an incident group node generator which checks whether any one node included in the first incident node generated by the incident node generator is connected to any one node included in a second incident node by an edge and generating a first incident group node in which the first incident node and the second incident node are connected by the edge.
